(19) United States
(12) Patent Application Publication
(10) Pub. No.: US 2026/0339489 A1
(43) Pub. Date: Oct. 29, 2026

(54) ACTION ENGINE AND ACTION INDEX FOR TASK PERFORMANCE

(71) Applicant: Microsoft Technology Licensing, LLC, Redmond, WA (US)

(72) Inventors: Suman K. NATH, Redmond, WA (US); Robert Warren GRUEN, Seattle, WA (US); Morris Eli SHARP, Seattle, WA (US); Lenin Ravindranath SIVALINGAM, Redmond, WA (US); Fazle Elahi FAISAL, Bothell, WA (US); Ryen William WHITE, Woodinville, WA (US)

(21) Appl. No.: 19/192,318

(22) Filed: Apr. 28, 2025

(51) Int. Cl. G06F 3/0484; G06F 9/451; G06F 9/54

(52) U.S. Cl. CPC G06F 3/0484; G06F 9/452; G06F 9/547; G06F 2209/545

(57) ABSTRACT

An action index includes information regarding an actionable graphical user interface (GUI) element of a GUI, an action for the actionable GUI element, a precondition for the action, and a postcondition for the action. A presence of the precondition in the GUI indicates a likelihood of success of the action, and a presence of the postcondition in the GUI, after performing the action, indicates success of the action. An agent performs a task on behalf of a user according to a plan that is based on the action index. The agent comprises an action engine which receives the task and obtains, from a generative artificial intelligence (GAI) model, the plan for completing the task.

### BACKGROUND

Modern artificial intelligence (AI) agents use generative AI technologies, including language models, to perform tasks based on a verbal or written prompt provided to the agent via a user interface. AI agents can run locally on a user's hand-held mobile device, laptop or desktop computer, or can run in remote datacenters. However, they are generally provided by a particular entity and are limited to performing specific types of tasks that relate to the products and/or services that the entity provides. For example, well-known AI agents are capable of purchasing an item on a marketplace platform on behalf of a user in response to a voice prompt. In enterprise systems, AI agents optimize workflows, perform cybersecurity tasks, and perform decision making in industries like finance, healthcare, and retail.

### SUMMARY

Example solutions for an action engine and an action index therefor are described herein. The disclosed examples are described in detail below with reference to the accompanying drawing figures listed below. The following summary is provided to illustrate some examples disclosed herein.

In certain examples, an action index includes information regarding an actionable graphical user interface (GUI) element of a GUI, an action for the actionable GUI element, a precondition for the action, and a postcondition for the action. In certain example scenarios, the action index includes action information related to an application programming interface (API) command that is unrelated to a GUI element. The precondition indicates a likelihood of success of the action, and the postcondition indicates success of the action. An agent performs a task on behalf of a user according to a plan that is based on the action index. The agent comprises an action engine which receives the task and obtains, from a generative artificial intelligence (GAI) model, the plan for completing the task.

### BRIEF DESCRIPTION OF THE DRAWINGS

The disclosed examples are described in detail below with reference to the accompanying drawing figures listed below:

FIG. 1A illustrates by way of example a system for deploying and accessing an artificial intelligence (AI) agent.

FIG. 1B illustrates an alternative deployment model for a system.

FIG. 2 shows a flowchart illustrating by way of example procedure for generating and using action index.

FIG. 3 shows a flowchart illustrating by way of example procedure for performing multi-page crawling to generate an action index from multiple web pages.

FIG. 4 shows an example representation of action index in the form of a knowledge graph.

FIG. 5 shows a block diagram illustrating, by way of example, architecture of action engine.

FIG. 6 illustrates an example grammar for a domain-specific language in which the plan is defined.

FIG. 7 illustrates an example procedure performed by an agent.

FIG. 8 shows a flowchart illustrating by way of example procedure for executing a task plan using generative AI model and an action index.

FIG. 9 is a time-space diagram illustrating by way of example a communication sequence among various system entities involved in performing a task.

FIG. 10 shows a browser window showing an example web page.

FIG. 11 is a block diagram of an example computing device for implementing technology disclosed herein.

Corresponding reference characters indicate corresponding parts throughout the drawings. Any of the figures or drawings may be combined into a single example or embodiment.

### DETAILED DESCRIPTION

Artificial intelligence (AI) agents are, in some cases, embedded into applications and interact with users and/or other systems. They use machine learning models built on neural networks that are trained using various training techniques, including supervised, unsupervised, or reinforcement learning. AI agents can be driven by a special-purpose model or an existing general-purpose generative AI (GAI) model. In either case, AI agents additionally require a number of components including a front end for user or automated interactions, a back end having an application programming interface (API) for integrating the agent with the AI model, memory and context management for long-term memory (e.g., to retain session content, and possibly retrieval augmented generation (RAG) functionality for fetching external data to enhance the agent's operation). Often, agents require custom code for advanced tasks, and specialized plugins and tools to connect agents with external systems such as calendars, emails, etc.

One technical challenge for custom AI agents is to perform tasks using existing human-facing interfaces that already exist, such as websites and mobile applications. Solutions have recently been introduced that leverage GAI systems to perform tasks on behalf of users using websites designed for human interaction, but they are computationally expensive and non-performant. In one approach, an agent is integrated with a web browser. Upon instructing the agent to perform a task, it sends the task to a remote GAI model which instructs the agent to navigate to a particular web page, then captures an image of the user interface generated by the web browser from the web page and sends the image to the GAI model for interpretation. The GAI model provides additional interaction instructions such as to click on a particular interactive user interface element, or type certain text into a text field generated by the website, and the process repeats until the task is complete. The back-and-forth communications and heavy reliance on GAI interactions results in high cost and slow performance.

In contrast, generating or updating, and making available, an action index with information that identifies available actions for a target service mitigates reliance on GAI models at agent run time. In certain examples, the action index includes information related to an actionable GUI element, the action, the precondition, and the postcondition, wherein the action index is accessible by a GAI model for generating a plan based on the action index, an AI agent can perform a task based on the plan with reduced processor load, less memory space required, increased processing speed, energy savings, reduced hardware requirements, enhanced reliability, reduced error rate, and reduced network bandwidth usage compared with prior approaches. For example, the action index obviates a need to forward screenshots of the GUI to the GAI model at runtime, thereby reducing network bandwidth usage and GAI processing of the screenshot images. This greatly reduces the overall computational cost of performing a task on a website or app. In comparison to approaches relying on analysis of the GUI definition such as hypertext markup language (HTML), the action index enables much more accurate identification of actions because the available actions are inferred by a GAI model based on the graphical display.

In addition or alternative to actions related to an actionable GUI element, the action index comprises information related to API calls for an API exposed by the target service. In this scenario, the action index is created based on an API definition including the API inputs and outputs, semantic descriptions, and information on how to invoke the API. API definitions can be imported from a service API specification/schema file, such as a web services description language (WSDL) formatted file, GraphQL protocol buffers (also referred to as “protobuff” or “.proto” definition), RESTful API Modeling Language (RAML), javascript open notation: API (JSON:API) files, OpenAPI specification (OAS), etc. In certain examples, the API definition includes its inputs and outputs, semantic descriptions, and pre-conditions defining when the API, or a particular API interaction, can be called, post-condition of successful completion of the API interaction, and information on how the API call can be invoked. In an example implementation, the precondition for issuing a particular API call is the availability of parameters (also referred to as “arguments” or “fields”) required by the API call, and the post condition comprises a success or failure message returned to the client by the API.

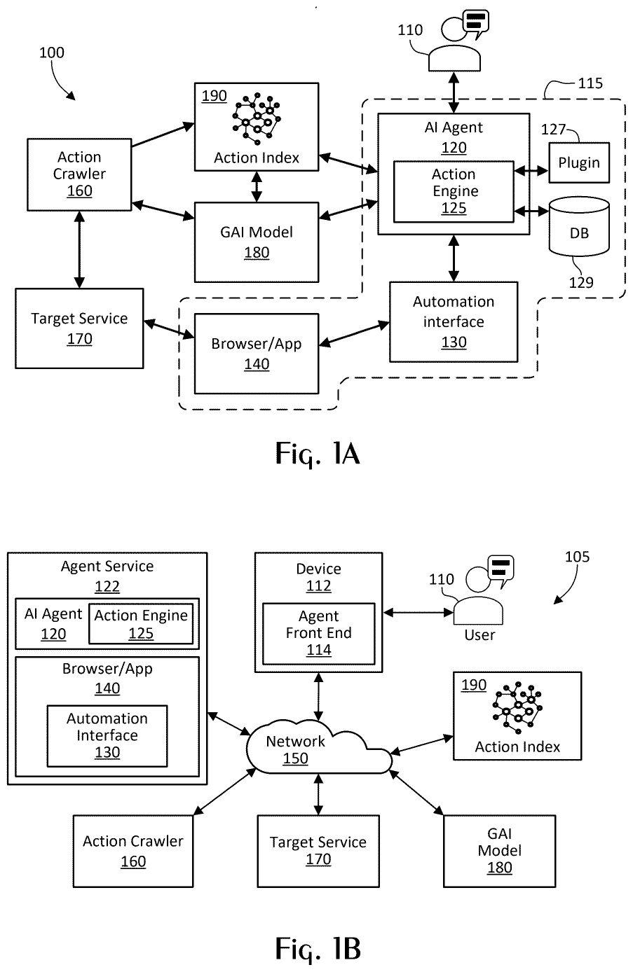

FIG. 1A illustrates by way of example a system 100 for deploying and accessing an AI agent. System 100 includes a user 110 accessing an agent 120 comprising an action engine 125 for performing actions requested by user 110. Action engine 125 is described in further detail below with reference to FIG. 5. Agent 120, in certain example implementations, employs one or more plugins 127 and can store data variables in database (“DB”) 129. Agent 120 controls browser/app 140 via automation interface 130. In an example implementation, automation interface 130 is a framework, such as Selenium (available as an open-source project) that interacts with a WebDriver component of popular web browsers. In an alternative implementation, automation interface 130 is a tool for controlling browsers using DevTools protocols. In other examples, other approaches that similarly drive a browser (headless or not) are used. In an alternative embodiment (not shown) browser/app 140 is a mobile application that interacts with a target service 170 via the internet. In this instance, automation interface 130 is implemented as an API or testing framework therefor.

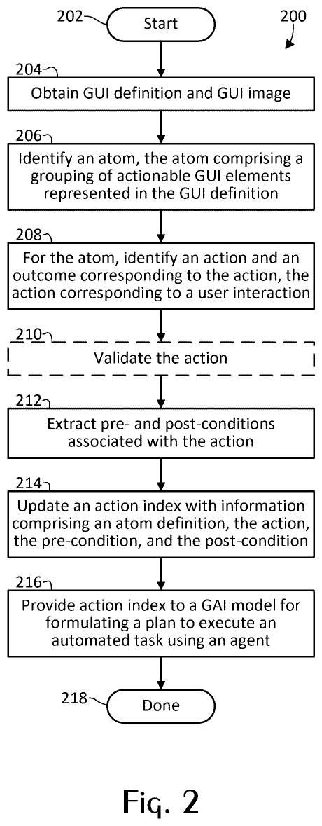

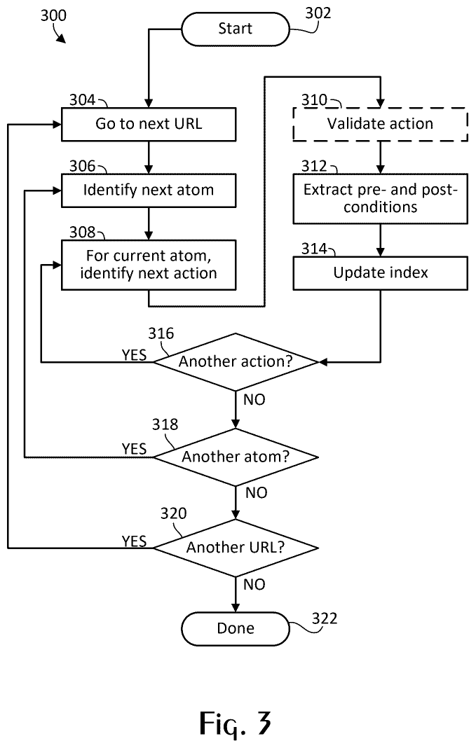

In an example implementation, browser/app 140 is a headless web browser suitable for accessing a website published by target service 170, e.g., via the internet. Action crawler 160 is described in further detail below with reference to FIGS. 2-4 and is used for crawling a website (e.g., website hosted by target service 170) to generate action index 190, which, in an example implementation, is a knowledge graph for informing agent 120 precisely what actions to take to navigate the website and/or API exposed by target service 170, and perform operations thereon.

Components 115 are applications, or components thereof, local to user 110 and execute on the user's device, which in various use cases, is a desktop computer, laptop computer, tablet, mobile phone, etc. Action crawler 160 is an application or component thereof executing in a location remote to user 110, such as within a cloud-based service. Likewise, GAI model 180 and target service 170 are services accessible via the internet or other wide area network. An example implements each of these services as a multitenant service, which comprises a scalable cluster of virtual machines or containerized application instances, across which the compute load is distributed using one or more load balancers. Alternative examples provide one or more services as a unitary, clustered, or microservices application deployed on one or more physical servers. Additional features, included based on implementation but not shown or described herein, include management interfaces, firewall and/or other security mechanisms, etc. Alternative embodiments include services that are subdivided into additional distinct systems with functionality distributed accordingly. Accordingly, the representations of system 100 are presented only as a possible implementation, or as one possible conceptual division of functionality, and should therefore not be considered restrictive.

FIG. 1B illustrates an alternative deployment model for a system 105 wherein agent 120 is deployed as a centralized service that is remotely accessed. In this case, device 112 is local to user 110 and agent service 122 is deployed in a remote datacenter (e.g., using a public cloud service). Agent service 122 comprises agent 120, which includes action engine 125 substantially as described above with reference to FIG. 1A. In addition, agent service 122, in certain example implementations, includes browser/app 140 (e.g., a headless browser or application server) and automation interface 130 therefor. In FIG. 1B, automation interface 130 is illustrated as a component of browser/app 140, whereas in FIG. 1A, automation interface 130 is illustrated separate from browser/app 140. Either approach is possible and functional blocks, including browser 140 and automation interface 130, should be understood as corresponding to code segments for implementing conceptual functionality that can be combined and/or subdivided depending on implementation details.

Device 112 includes agent front end 114 which receives a request from user 110 (e.g., via a chat interface) and forwards the request to agent service 122, which then returns responses to user 110. Requests are spoken or written, and additional interactions are possible as further described herein. Agent service 122 is a service accessible via the network 150, which comprises the internet and/or other wide area networks and local networks. Agent 120 and browser/app 140, and automation interface 130, are, in some example implementations, deployed as a unitary service on a physical server computer. In alternate implementations, agent 120 and browser/app 140 are deployed separately in individual physical server computers and can be deployed as scalable services (e.g., using virtual computing or containerization). In this case, there are multiple instances of agent 120 and browser/app 140 distributed across multiple physical server computers.

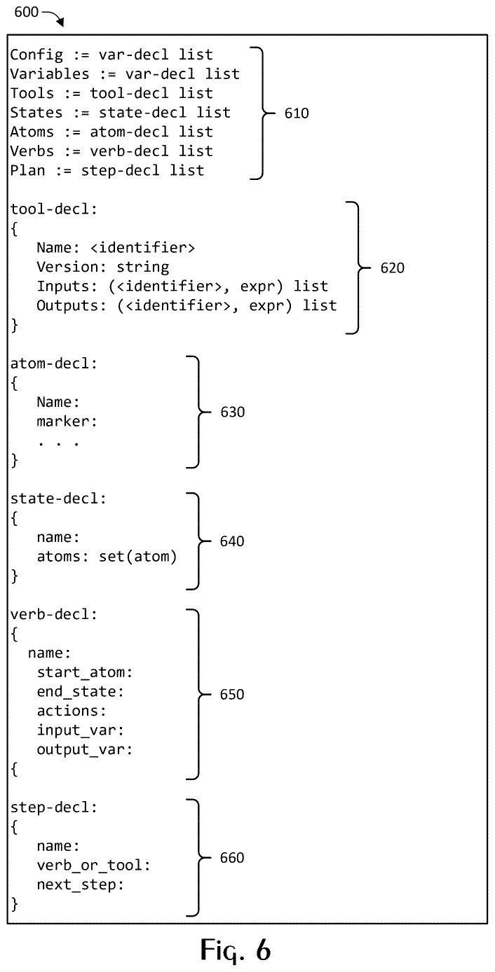

Regardless of the deployment model (e.g., as shown in FIG. 1A or 1B) agent 120 receives the request from user 110, obtains a plan therefor, which is informed by action index 190, from GAI model 180, and then executes the plan via automation interface 130 on browser/app 140 and/or directly with a target service 170 via an API. Browser/app 140 accesses a target service 170 which enables the request to be completed according to the plan determined by GAI model 180. These interactions are described in more detail below such as with reference to FIGS. 6-8.

In certain scenarios (not shown) browser/app is self-contained and requires no external target service 170. In this instance AI agent 120 interacts with an API exposed by browser/app 140 which performs functions as directed by AI agent 120 according to the plan devised by GAI model 180 based on action index 190 as further described below.

FIG. 2 shows a flowchart illustrating by way of example procedure 200 for generating and using action index 190. In an example embodiment, this procedure is performed by action crawler 160. Procedure 200 comprises operations that in alternate implementations are combined and/or supplemented with additional operations, or are performed in an order other than that shown unless logic dictates otherwise.

Procedure 200 initiates in operation 202 and proceeds to operation 204 wherein a GUI definition and a GUI image are obtained. In an example implementation, action crawler 260 accesses target service 170 using a uniform resource locator (URL) and retrieves hypertext markup language (HTML) that defines a GUI for a particular web page identified by the URL. In addition, a “screenshot” of the web page is generated. In an example implementation, action crawler 160 employs a headless browser driven by an automation interface such as Selenium to obtain the GUI definition and the GUI image. Headless browsers are capable of obtaining “screenshots” of a web page entirely within memory and without actually displaying the web page on a display screen. In an alternate embodiment, a testing framework for driving a mobile application, windows application, or other type of application is employed for capturing a GUI definition and GUI image thereof. In cases where the target service 170 exposes an API instead of a website, operation 204 comprises obtaining an API definition, such files in WSDL, GraphQL, protobuff definition, RAML, or OAS, format as previously described.

In operation 206, an atom is identified from the GUI definition and GUI image. The term “atom” refers herein to a collection of one or more related GUI elements that serve a particular purpose. Each atom has a signature (e.g., a string of text) that establishes, with reasonable certainty, that the atom (and therefore the collection of GUI elements) is present. An example atom in a website might be a search bar that includes a collection of interactive (or “actionable”) elements including a text box for entering a search string and a search button to initiate a search. A particular website (e.g., a collection of web pages on the same domain or closely related domains, such as owned by the same entity) might include the same atom on multiple web pages. For example, a popular shopping website might include the search bar on its landing page and on every product page. Even though the landing page may be dynamically generated and appear differently to different users (e.g., based on their language, the location, and their shopping history) the presence of the atom is detected by its signature. An example signature may be the phrase, “Search Products” that appears in or adjacent to the search text field alone or in conjunction with code (e.g., HTML code) identifying the interactive elements that make up the search bar.

The atom and its signature are identified with the assistance of GAI model 180. That is, the GUI definition and GUI image are provided to GAI model 180 with instructions to identify atoms on the web page, including instructions to determine a signature for each atom identified. For an API, the atom is the uniform resource identifier (URI) of the API endpoint, in some examples. The atom's signature, in an embodiment, is the receipt of a ping response, authentication confirmation, or readiness or other state indication from the API.

In operation 208, an action and an outcome corresponding to the action is identified for the identified atom, wherein the action corresponds to a user or API interaction. Users interact with actionable elements of the GUI by, for example, clicking a link or a button, right-clicking, shift clicking (e.g., holding the shift key down while clicking), entering text, tapping (for touch-sensitive displays), double-tapping, etc. GAI model 180 is asked to infer one or more actions for each atom and to associate the actions with the atom. API interactions comprise API calls to the browser/app 140 or to target service 170.

In optional operation 210, the action is validated, for example, by executing the action and capturing a state of the GUI (or API response) after the action is executed. For example, crawler 160 programmatically clicks a link or a button in the GUI (e.g., via a headless browser) and then captures the GUI definition and the GUI image of the response. For example, clicking a shopping cart link will result in navigating to a page showing items in the user's cart, and crawler 160 captures the GUI definition and the GUI image, and sends these to the GAI model for evaluation to validate the inferred purpose of the action.

In an example where the action is directed to an API, validation comprises executing the API call, obtaining a response to the API call, including the status code, providing the output to the GAI model, and requesting the model to confirm, based on the output, that the outcome is achieved.

In operation 212, preconditions and postconditions, that are associated with the action, are extracted from the first GUI or API definition that was obtained before the action was executed and a second GUI or API definition that was obtained after the action was executed. The precondition is a signature associated with the action, and the postcondition is a signature associated with the result of the action. If the result is navigation to a new web page, then a signature for the page (“page signature”) is extracted, wherein the page signature is the collection of atom signatures on the page. In this example, a signature is an attribute of the GUI definition that establishes with relative certainty that the interactive element upon which the action is taken (e.g., the link, button, text-field, etc.) is present and that the action will be successful. In an example, performing a search requires that the search bar be present, and therefore, the signature is the presence of the “Search Products” text mentioned above. The result signature is a similar presence of some text or attribute of the resulting (second) GUI definition that establishes with relative certainty that the action was successful. The result of a successful search might be a listing of products (e.g., with the heading “Search Results”). In this case, the presence of the text “Search Results” can be selected as the extracted postcondition indicating successful completion of the action. The precondition and the postcondition are selected by the GAI model in response to instructions to identify text or attribute of the GUI that establishes a successful result from the action.

Where the action is performed on an API, the precondition can be considered that both AI agent 120 and browser/app 140 (or target service 170) are in a state suitable for executing the action, i.e., transmitting the API call, whereas the postcondition is the state of both AI agent 120 and browser/app 140 (or target service 170) are in an expected or successful outcome state. The signature of precondition is the indication of availability of the API and the availability of parameters required for the API call. The signature of the postcondition is the receipt of the response from the API indicating a successful outcome.

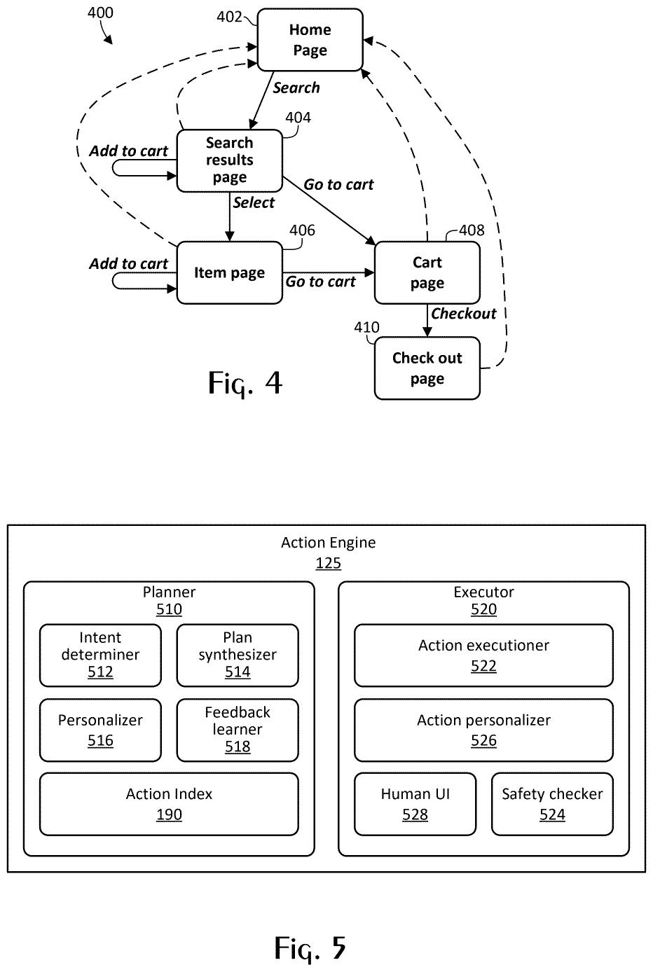

In operation 214, the action index is updated with information collected in operations 206-212. As further described below with reference to FIG. 4, action index 190 is, in certain embodiments, structured as a knowledge graph. Each action is a verb, or edge, in the knowledge graph that connects two nodes. Nodes represent web pages or “states” of the website or application. Each node has properties including the available atoms, the actions of each atom, and the preconditions and postconditions for each of the actions. In an example implementation, the graph is represented in serialized form, for example, using a structured data interchange format such as JavaScript Open Notation (JSON) or Extensible Markup Language (XML). In other implementations, a flat-file database is employed to capture collected information. In any case, as information is collected by crawler 160, it is added to action index 190.

In another example implementation, action crawler 160 is integrated into or co-located with or in communication with target service 170 and/or a back-end application server (not shown). As an action crawler performs actions on the GUI, it receives network traffic between target service 170 and the back-end application server that results from the actions performed on the GUI, and infers API calls resulting from the web interactions. Action index is then updated with these API actions so that web interaction is not required. For example, a search box allows a user to enter some text which does a lookup on a back-end service and reports those results back to the user. The action indexer performs the same GUI manipulations and gets the same result (such as described above). In conjunction with these interactions, it records network traffic, infers from the network traffic the API action resulting from the GUI interactions, and updates the action index with the API interactions so that future interactions directed by the agent, as further described herein, perform the same API actions without interaction with the GUI.

In operation 216, the action index is made accessible to or provided to GAI model 180 for use in formulating a plan to execute an automated task using an agent. The procedure then ends at operation 218. In an example, AI agent may pass a task submitted by user 110 with an instruction to generate a plan to complete the task using actions defined by action index 190, along with portions of action index 190 corresponding to target service 170.

FIG. 3 shows a flowchart illustrating by way of example procedure 300 for performing multi-page crawling to generate an action index from multiple web pages. In an example embodiment, this procedure is also performed by action crawler 160. Procedure 300 expands upon the operations described above with reference to FIG. 2 by repeating them across multiple URLs and multiple atoms per page, thereby building a comprehensive action index spanning a variety of user interactions across an entire website or application. Procedure 300 comprises operations that in alternate implementations are combined and/or supplemented with additional operations, or are performed in an order other than that shown unless logic dictates otherwise.

Procedure 300 begins at operation 302 and proceeds to operation 304, wherein the crawler navigates to the next URL. This may be the initial URL at the start of a crawling session, or it may be a subsequent URL identified during the session, such as through site map discovery or link traversal. In an example implementation, URLs are queued and selected sequentially for processing.

In operation 306, an atom is identified from the current page, consistent with the techniques described in operation 206 of FIG. 2. Atoms may be identified based on GUI signatures and actionable elements derived from the GUI definition and image for the current page.

In operation 308, the next action associated with the current atom is identified. This step may include inferring potential user interactions as described in operation 208 of FIG. 2. If an atom supports multiple actions (e.g., a search bar may allow search submission and suggestion selection), each is processed in turn.

Operation 310 optionally validates the selected action by executing it and capturing the resulting GUI definition and image, as described in optional operation 210 of FIG. 2.

In operation 312, the crawler extracts preconditions and postconditions associated with the action, consistent with operation 212 of FIG. 2. These conditions define the context and result of the action and are used to characterize the action's behavior.

Operation 314 updates the action index with information about the atom, the action, and its conditions, as described in operation 214 of FIG. 2. In an example implementation, the index is updated incrementally after each action is processed.

Decision operation 316 determines whether there is another action to process for the current atom. If so, flow returns to operation 308 to identify and process the next action.

If there are no additional actions, decision operation 318 checks whether another atom remains to be processed on the current page. If so, flow returns to operation 306 to process the next atom.

If all atoms on the current page have been processed, decision operation 320 checks whether another URL is available for processing. If so, flow returns to operation 304 to load and process the next web page. If there are no further URLs, the procedure concludes at operation 322.

FIG. 4 shows an example representation of action index 190 (or portion thereof) in the form of a knowledge graph 400 that models a sequence of user interactions with an example e-commerce website. In an example implementation, this graph is constructed by action crawler 160 using the procedures described above with reference to FIGS. 2 and 3. The knowledge graph structure enables intelligent reasoning over the navigational flow and supported actions of a website or application and may be leveraged by GAI model 180 for planning and executing high-level tasks, such as purchasing an item.

In this example, each node of graph 400 represents a unique page or GUI “state,” while the directed edges represent actions that transition between pages. The nodes include, for example, home page 402, search results page 404, item page 406, cart page 408, and checkout page 410. Each edge is labeled with a corresponding action (e.g., “Search,” “Select,” “Add to cart,” “Go to cart,” or “Checkout”), representing an interaction a user can perform on the originating page that results in a transition to the target page.

Graph 400 is constructed by identifying and indexing atoms and actions as described above. Each edge is associated with metadata (not shown) including the action signature, precondition signature, and postcondition signature, which are inferred and validated by GAI model 180 as described above with reference to FIGS. 2 and 3. For instance, the “Search” action from home page 402 to search results page 404 may be represented by entering a search string in a text field and clicking a button, with the corresponding precondition being the presence of the search bar and the postcondition being the appearance of results.

The graph also captures alternate paths to reach a particular state. For example, a user may add an item to the cart from either the search results page 404 or the item page 406. This is reflected in the “Add to cart” edges that loop back to search results page 404 and item page 406. Similarly, the graph captures paths to return to home page 402 illustrated with dashed lines.

Graph 400 is simplified compared to an actual action graph of a real website or application. Action graph 190 may contain many application-or website-specific graphs, each for a corresponding target service, and it is possible that one graph can link to another graph. For example, performing an operation on one website can trigger the website to direct a user (or agent 120) to a different website, e.g., for authentication, to complete a purchase, or to retrieve requested content.

In an example use case, GAI model 180 leverages graph 400 to plan and execute a high-level task, such as purchasing an item from the online store. Given a goal state (e.g., reaching checkout page 410 with an item in the cart), the GAI model performs path planning over the graph. It identifies a valid path beginning at home page 402, traversing through one or more intermediate states (e.g., search results page 404 and item page 406), executing required actions (e.g., “Search,” “Select,” “Add to cart”), and ultimately reaching the goal state by executing “Go to cart” and “Checkout.”

Because each edge in the graph is backed by actionable GUI or API data and validated preconditions and postconditions, the resulting plan is both semantically meaningful and executable by an automated agent with a high degree of confidence in obtaining the desired outcome. Moreover, the graph enables flexibility and adaptability as further described below.

Although graph 400 is directed specifically to GUI actions, in other implementations or scenarios, graph 400 of an action index includes edges that correspond to API actions (calls) or external domain-specific agents or tools and nodes that represent states thereof.

FIG. 5 shows a block diagram illustrating, by way of example, architecture of action engine 125. An action engine is a system that can automatically execute complex tasks on existing websites and applications based on natural language descriptions thereof from the user. For example, the user might request agent 120 to “download all my bank statements from last year.” The action engine interprets the user's intent and uses one or more GAI models, AI agents, or tools to accomplish the task. To accomplish a complex task, action engine breaks it down into a sequence of actions and performs them on relevant websites and applications, either by interacting with their user interfaces (UIs) or underlying application programming interfaces (APIs), or by employing external domain-specific agents and tools. In certain implementations and scenarios, the action engine requires minimal user interaction to handle tasks beyond its capabilities, such as solving a captcha or obtaining additional information about that task that is not included in the initial task description, to deal with system exceptions when the output is unexpected or task progress is slow, or to give users more control over the action engine's operation (e.g., the specific website, application, or tool it uses to make task progress).

Action engine 125 includes planner 510 and executor 520. As illustrated in FIG. 5, planner 510 and executor 520 each include a number of modules which are represented as functional blocks. Functional blocks correspond to segments of code which may be implemented in numerous ways as previously explained above with reference to functional blocks shown in FIGS. 1A and 1B. Planner 510 receives the task the user wants to complete as input and generates, using plan synthesizer 514 and action index 190, a plan of actions for completing the task. Planner 510 may, using personalizer 516, use the user's profile, preferences, and task history of completed tasks, and leverage foundation models or specialized planning algorithms. For instance, a user may ask the action engine to “renew all checked-out library books for one more month.” The action engine then creates a plan of actions that includes (1) opening the user's default library website (found from the user's profile via personalizer 516), (2) logging in if necessary and if the user has given login consent, (3) navigating to the “checked-out books” section of the website, (4) selecting all books, (5) clicking on the “renew” button, and finally (6) verifying that the final page contains the confirmation text “all books renewed.”

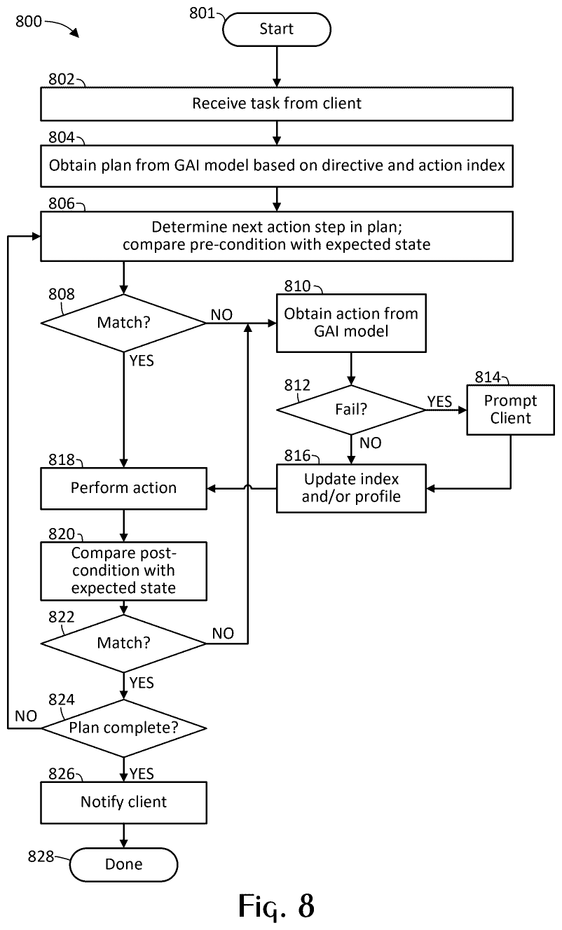

Executor 520 carries out each step in the action plan by interacting with the target application or website UI or underlying APIs. In an example implementation, executor 520 leverages foundation models to determine how to perform an action. In an example, to execute the action “click the ‘renew’ button,” the executor uses a GAI model to locate the target button on the current website screen. Executor uses the user's profile and preferences (e.g., to log in to their account or to choose an option), external tools, or even other AI agents. For example, if the library website has an AI agent or an API that can do the renewal task, action engine 125 might interact with it to perform the task. Planner 510 and executor 520 work together: the planner generates a few steps that the executor performs. Based on the outcome of these steps, planner 510, in certain scenarios, will generate more steps for executor 520. The loop, in certain examples, also includes the user (via Human UI 528) e.g., to clarify the user's intent, to handle exceptions, to help the agent perform new tasks, or to complete a complex task with human-agent collaboration. Human inputs and feedback are, for example implementations, leveraged to fine-tune or retrain the foundation model to improve its accuracy using feedback learner 518, as further described below with reference to FIG. 8.

In example implementations, action engine 125 utilizes APIs exposed by a target service and/or external tools to perform tasks. However, in some examples, APIs and/or external tools are not mandatory for task execution. A significant advantage of this design is that the action engine can accomplish tasks by interpreting and interacting with application or website user interfaces.

Planner 510 infers the user's implicit and explicit intent (using intent determiner 512), asks the user for any missing or disambiguating information, and uses the user's profile, preferences, and task history to generate a complete or partial action plan. To generate the plan, planner 510 obtains from action index 190 the set of possible actions, as well as their semantics, which can be performed on different websites, applications, or APIs. The plan is accurate and safe, meaning that it not only achieves the user's goal, but also avoids any unintended side-effects. Safety checker 524 ensures safety by applying semantic or heuristic rules to actions and generating exceptions or user confirmations for certain actions. In examples, the plan is personalized using personalizer 516 as previously mentioned, by taking into account the user's long-term and short-term interests, as well as the user's feedback and behavior over time. For example, personalizer 516 maps the identified intents from intent determiner 512 to task plans of other users with similar interests and preferences, and then refines the plan based on the individual user's characteristics and preferences. The personalizer 516 and intent determiner 512 employ GAI model 180 to identify user characteristics and preferences and intent, respectively, and maintain this information in database 129. In addition, plan synthesizer can instruct executor 520 to identify variable values and store them in variable storage in database 129 for later use, based on the requirements for completing the user-assigned task.

Executor 520 performs each step of the plan by identifying the correct interaction target (e.g., UI control, API, tool, or agent) and verifies that each action is performed as expected. Action executioner 522 ensures that the task execution is safe, reliable, secure, and personalized, via safety checker 524 and action personalizer 526. In certain implementations, speed is emphasized depending on the task and the circumstances. It should also be able to involve humans via human UI 528 for any critical steps, such as unblocking an operation with a login or providing additional information. Feedback learner 518 improves planner 510 and executor 520 over time, improving based on their experiences and feedback across multiple websites or applications, and improving their performance and robustness. Reinforcement learning can be useful here, using, for example, task outcome as the reward function.

FIG. 6 illustrates an example grammar 600 for a domain-specific language (DSL) in which a plan is defined. In an example implementation, the planner 510 generates a plan constructed from the DSL which is executed by executor 520 in a sandbox to ensure security. The DSL is defined for encoding and executing plans that operate over action index 190, and serves as a structured and interpretable grammar for the action engine, enabling GAI model 180 or other planning component to define, represent, and execute a task plan involving GUI and API actions across multiple states and atoms. The grammar of the DSL supports modular and extensible declarations for tools, GUI elements, states, actions (verbs), and execution plans (steps). The DSL may be interpreted or compiled by the action engine and executed.

Grammar 600 includes productions 610. Each production defines a set of semantic elements that may be referenced by other components in the DSL. For instance, the States, Verbs, and Steps collectively define the transitions and logic necessary to navigate through a series of GUI states using defined user actions.

The tool-decl declaration 620 defines reusable tools, which may correspond to code modules, scripts, or models that process input data to generate output. These tools can be integrated into a plan and invoked as part of the action sequence. Each tool is versioned and accepts named inputs and outputs, supporting data flow tracking within a plan. Tools may include utility functions such as search term generation, form filling, result parsing, or language model invocations.

The atom-decl declaration 630 defines atoms that group together actionable GUI elements such as search bar product selector. Each atom may be associated with a GUI signature (“marker”) used for identification and interaction.

The state-decl declaration 640 defines a GUI state, such as a rendered web page or screen of an application, and includes a set of available atoms. Each “state” represents a node in the knowledge graph representation of action index 190. The presence of particular atoms in the state defines the actions that can be taken from it.

The verb-decl declaration 650 defines an action that transitions the system from one state to another. Verbs correspond to labeled edges in the knowledge graph (e.g., “Search,” “Add to cart,” “Checkout”), and are associated with an input atom, an expected end state, and any intermediate actions or data flows. Each verb models a semantically meaningful interaction (e.g., clicking a button, selecting a menu item, or completing a form) and optionally associates input/output variables for dynamic data binding during plan execution.

Finally, the step-decl declaration 660 defines an ordered step in the overall plan. A step may invoke a verb or tool, and optionally identifies the next step to be executed.

Steps form a chain or branching sequence that defines the flow of the plan execution. For example, a plan for purchasing an item may consist of the following high-level steps: (1) execute a search verb, (2) select a result, (3) invoke a verb to add the item to the cart, (4) go to the cart page, and (5) invoke the checkout verb. In this manner, the DSL functions as an interpretable and composable grammar for task automation. It enables abstraction over concrete GUI actions, supports reasoning about available states and transitions (via the action index), and facilitates execution by a downstream agent. The structure of the DSL also allows for validation, debugging, and dynamic re-planning when GUI conditions or expected outcomes change, as described below with reference to FIG. 8.

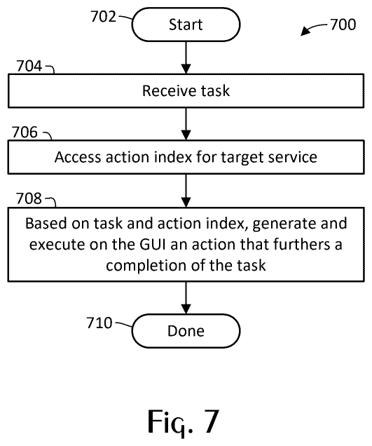

FIG. 7 illustrates an example procedure 700 performed by agent 120, wherein the agent utilizes action index 190 to assist in completing a task. The procedure begins at operation 702, where the AI agent initiates execution. In operation 704, agent 120 receives a task. The task may be provided by a user, another software system, or a task scheduling component, and may specify an objective to be accomplished through interaction with a particular GUI associated with target service 170.

In operation 706, agent 120 accesses action index 190 to obtain available actions, e.g., in the form of a graph as described above with reference to FIG. 4, for the target service or website. In example implementations, the action index is retrieved as file containing a data interchange format (JSON, XML, etc.) or by accessing a database.

In operation 708, based on the action index and the received task, the AI agent generates, e.g., using GAI model 180, a plan comprising action and executes the action on the GUI or API. The response is directed toward furthering the completion of the assigned task, and by way of example, includes simulating user input, selecting options, submitting forms, or triggering other interactive elements within the interface. The procedure concludes at operation 710. In an example scenario, a plan comprises a first action on a GUI generated by a website and a second action comprising an API call to an API endpoint.

FIG. 8 shows a flowchart illustrating by way of example procedure 800 for executing a task plan using GAI model 180 and an action index 190. In an example implementation, this procedure is performed by agent 120 having an action engine 125 that is in communication with GAI model 180 and has access to action index 190. In an example embodiment, procedure 800 enables intelligent execution of a multi-step plan defined in a structured format, such as the DSL described above, and makes use of precondition and postcondition validation to ensure robust task performance across dynamic GUIs.

Procedure 800 begins at operation 801 and proceeds to operation 802, in which a task is received from a client. The client may be a user interface, application process, or orchestration layer that provides a directive such as “Buy hiking boots,” “Download my billing history,” or any other user goal. The directive may be in natural language or structured input format.

In operation 804, a plan is obtained from GAI model 180. The plan is generated based on the received directive and the contents of action index 190, which may be represented as a knowledge graph (see FIG. 4) comprising states, atoms, verbs, and their associated preconditions and postconditions. In some embodiments, the plan is provided in DSL format as described above and includes an ordered list of action steps.

In operation 806, the action engine determines the next action step in the plan and compares the associated precondition with the expected state (e.g., the current GUI). The precondition is derived from the action index and serves as a predicate for determining whether the expected state (e.g., current page or GUI state) is suitable for the next action to be performed. In an example, agent 120 checks GUI definition (e.g., HTML) for the presence of a signature establishing that the necessary atoms/interactive elements are present for executing the action.

In operation 808, if the precondition matches the expected state (e.g., the current GUI), flow proceeds to operation 818 to perform the action. Otherwise, flow proceeds to operation 810 to request assistance from the GAI model. In operation 810, the GAI model is invoked to resolve the mismatch by inferring a suitable alternative action or suggesting a revised navigation path. In an example implementation, action engine 125 retrieves the GUI image (e.g., a virtual screenshot of the GUI as generated by a browser) and provides this along with the GUI definition to the GAI model, and the model is directed to identify the atom, action, and preconditions and postconditions as previously described above with reference to action crawler 160 in FIGS. 2 and 3.

At operation 812, the inferred action is evaluated for validity. In this instance, action engine 125 performs validation in a manner similar to that of action crawler 160 as previously described to verify that the action obtained the expected result. If the action is deemed to fail (e.g., it is invalid, leads to an unexpected result, or fails to satisfy the user goal), flow proceeds to operation 814, wherein the client is prompted for clarification or updated instructions. This may involve rephrasing the task directive or providing missing context and/or information.

If the alternative action is successful, or after a clarification is received from the client, operation 816 updates the action index and/or user profile based on the new knowledge. For example, the action index may be updated to reflect newly learned transitions, atoms, and/or precondition/postcondition signatures.

In operation 818, the validated or original action is executed. This may include virtualized user interactions such as clicking, typing, submitting a form, or navigating to another page via the headless browser or automation engine.

In operation 820, the postcondition of the action is compared with the expected state (e.g., the resulting GUI definition). This determines whether the action had the intended effect. For example, if the action was “Add to cart,” the expected postcondition may be the presence of a confirmation message or updated cart total.

In operation 822, if the postcondition matches the expected result, flow proceeds to operation 824. If not, execution may revert to operation 810 to re-evaluate the action or request intervention.

In operation 824, a determination is made as to whether the plan is complete. If additional steps remain in the plan, execution returns to operation 806 for the next action. If the plan is complete, flow proceeds to operation 826.

In operation 826, the client is notified that the task has been completed. This may include returning a status message, a summary of the actions performed, or the final GUI state resulting from execution. Procedure 800 concludes at operation 828.

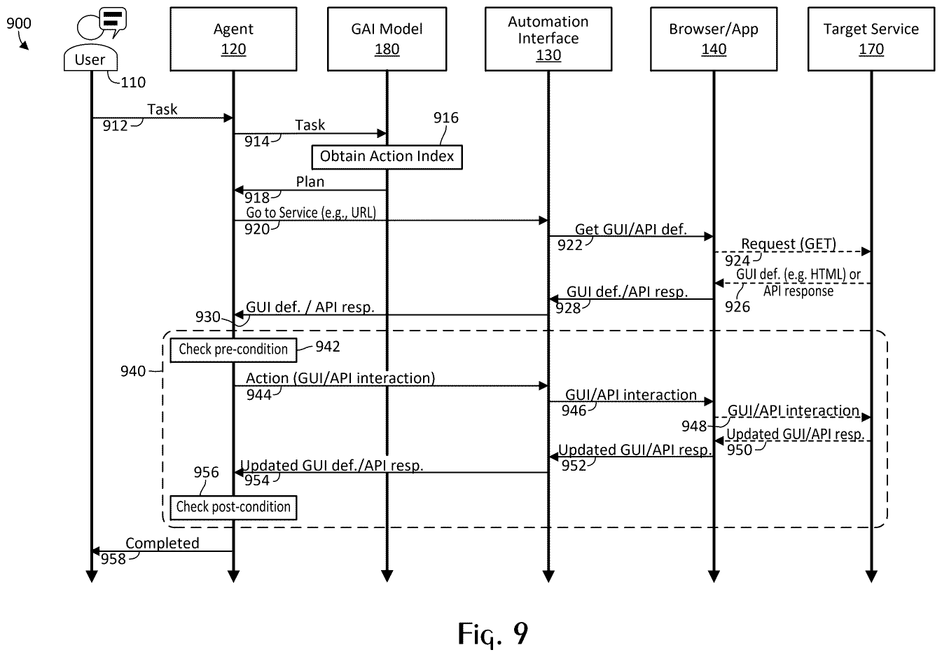

FIG. 9 is a time-space diagram illustrating by way of example a communication sequence 900 among various system entities involved in performing a task using annotated GUI information. The entities are shown along the horizontal axis and include user 110, agent 120, GAI model 180, automation interface 130, browser/app 140, and target service 170. Vertical lines extending downward from each entity indicate the temporal progression of actions performed by each respective entity. Horizontal arrows represent messages exchanged between the entities, with message direction indicating the sender and recipient.

The process begins when a user provides a task to the agent 120 in message 912. The task, in example embodiments, is provided in spoken or written natural language. In response, agent 120 relays the task to GAI model 180 via message 914. The task is provided to GAI model with additional instructions for interpreting and responding to the task. Specifically, in an example embodiment, GAI model 180 is instructed to access action index 190 in operation 916 and to generate plan 918 in DSL based on the task and action index 190 as previously described. Plan 918 comprises one or more actions (e.g., as defined in the DSL) to be performed on a GUI.

In an example implementation, plan 918 instructs agent 120 to navigate to a particular website or API provided by target service 170. In this case, plan 918 may include a set of actions mapped by action index 190, thereby defining a “path” through the knowledge graph to achieve completion of the user's task. Additional steps in the plan may be to pull personalization information from the user, store information in variables, or invoke other external plugins as previously described.

In response to plan 918, the example shown provides that agent 120 issues message 920 to automation interface 130, instructing automation interface 130 to retrieve the GUI or API definition associated with a web page or API published by target service 170.

In response to receiving message 920, automation interface 130 transmits a request 922 to the browser/app 140 to retrieve the GUI definition or an API response. In an example, request 922 may be implemented as a request to navigate to a target URL and retrieve the HTML therefrom or as an authentication or ping of an API service. For a web-based service, browser/app 140 issues a GET (message 924) to the URL of target service 170 and retrieves the HTML from the target service 170 via message 926. For an API service, a ping, session initiation, authentication, or similar action is performed to obtain a precondition signature from the API service as previously described.

In message 928, browser/app 140 forwards the GUI definition or API response to automation interface 130 which forwards it in message 930 to agent 120.

Communications 940 indicated by a dashed line highlights a loop of interactions that are, in certain implementations and/or scenarios, performed iteratively or according to plan 918 determined or obtained by AI agent 120. This loop includes operations 942 and 956, as well as messages 944-954. In operation 942, AI agent confirms the presence of the precondition for the next action in plan 918. In an example, the precondition may require that a particular atom is present, so the GUI definition is checked for the presence of the atom. In an alternate example where the target service publishes an API, the precondition is similarly checked as previously described. After confirming the presence of the atom, the action is forwarded to automation interface 130 via message 944.

Automation interface 130 converts message 944 to an instruction understandable by browser/app 140 in message 946. Optionally, and responsive thereto, browser/app 140 communicates with target service 170 via messages 948 and 950 to perform the action and obtain an updated GUI definition or API response resulting therefrom. Browser/app 140 provides the updated GUI definition or API response to automation interface 130 via message 952, which provides it to agent 120 via message 954. In operation 956, agent 120 confirms the postconditions are present by comparing, in one scenario, the GUI definition with signatures indicating the action achieved the expected result. In an alternate scenario, the postcondition is confirmed by comparing an API response with an expected API response.

Communications 940 are repeated as necessary until the task is complete, whereupon agent 120 informs user 110 that the task is complete in message 958 (e.g., by displaying a complete message or icon).

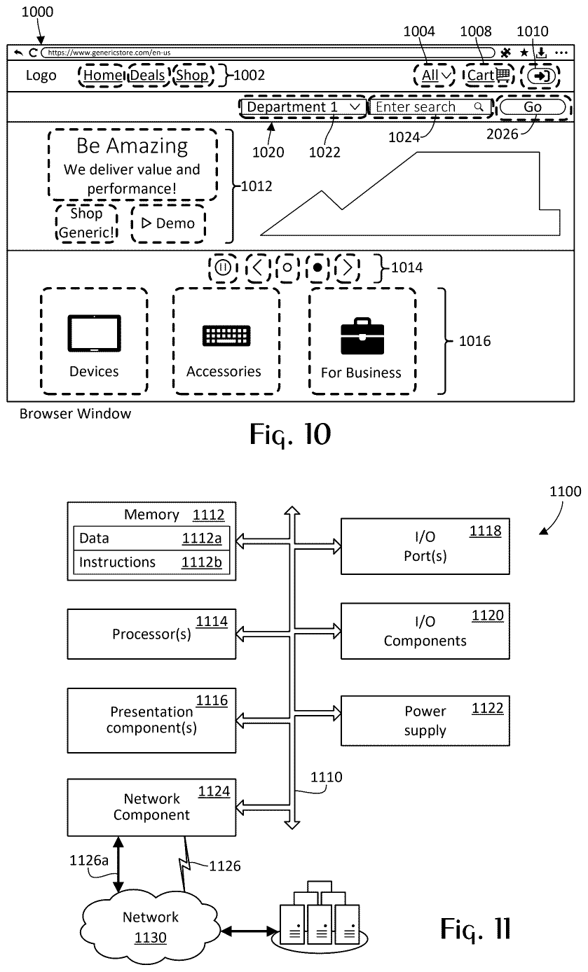

FIG. 10 shows a browser window 1000 showing an example web page generated by “Generic Store.” Highlighted by dashed lines are interactive elements including link group 1002 in the header, along with all menu link 1004, cart link 1008, and sign-in button 1010. Together these elements can be identified as a header bar atom. Atom 120 is another group of interactive elements forming a search bar that includes a drop-down menu 1022 for selecting a department, a text field 1024 for entering a text string, and a go button 2026 for initiating a search. Additional interactive elements on web page shown in browser window 1000 include links 1012 and 1016, and animation controls 1014. Semantic rules and heuristics can exclude certain links from being separately indexed by index crawler 160. For example, the “shop generic!” link in grouping 1012 is redundant of the “shop” link in group 1002, and can therefore be ignored. In other words, clicking either link directs the user to the same target web page. Similarly, animation controls 1014 may be recognized as relating only for displaying marketing content and therefore not important for navigating the website.

### Additional Examples

In some examples, entries in the action index are graphs corresponding to action sequences for specific tasks.

An example computer system comprises a processor and a memory storing instructions for execution by the processor, the instructions being operative upon execution by the processor to: for a graphical user interface (GUI), obtain a GUI definition and a GUI image, the GUI definition being serialized code describing the GUI, and the GUI image being a representation of a GUI display corresponding to the GUI definition; identify an actionable GUI element represented in the GUI definition and in the GUI image, the actionable GUI element being configured for receiving an interaction by a user; identify a first action corresponding to the interaction; extract a precondition and a postcondition corresponding to the first action, the precondition being a presence, prior to the execution of the first action, of a signature indicating that the actionable GUI element is present, the postcondition being a presence, after the execution of the first action and within a second GUI definition retrieved after execution of the first action, of a signature indicating an outcome from the first action; for an application programming interface (API), obtain an API definition comprising inputs and outputs for the API, semantic descriptions, and information for invoking the API, and identify a second action corresponding to an API call to the API; and update an action index with information that identifies the actionable GUI element, the first action, the precondition, the postcondition, and the second action, wherein the action index is made accessible by a generative artificial intelligence (GAI) model for generating a plan based on the action index to execute an automated task.

Alternatively, or in addition to the other examples described herein, examples include any combination of the following:
Wherein the generating of the plan comprises receiving, by the GAI model, a task and instructions to create the plan based on the action index to complete the task, the plan comprising the first action or the second action.
Wherein the instructions are further operative upon execution to validate the first action and the second action, the validation comprising: obtaining a second GUI image; providing the second GUI definition and the second GUI image to the GAI model; requesting from the model, a confirmation, based on second GUI definition and the second GUI image, that the outcome was achieved; obtaining output from the API in response to the second action; providing the output from the API to the GAI model; and requesting from the model, a second confirmation, based on the output from the API that the outcome was achieved.
Wherein the actionable GUI element is part of an atom, the atom having a corresponding signature, the signature indicating that the atom is present.
Wherein the GUI is one of a plurality of web pages published by a website, the atom is one of a plurality of atoms of the GUI, and the first action is one of a plurality of actions for the atom, instructions further being operative upon execution to iterate through the plurality of actions, the plurality of atoms, and the plurality of web pages.
Wherein the action index is organized as a directed graph wherein each node in the directed graph is a GUI screen or API state and each edge is one of (i) a corresponding action that changes the GUI from one GUI screen to another, or (2) a corresponding API calls that changes the API from one state to another, the edges having properties comprising a corresponding precondition and a corresponding postcondition.

An example computerized method for performing a task comprises: generating an action index, the action index comprising: first information, for a graphical user interface (GUI), regarding an actionable GUI element of a GUI screen, the first information comprising a first action for the actionable GUI element, a precondition for the first action, and a postcondition for the first action, wherein the GUI meeting the precondition indicates a likelihood of success of the first action, and the GUI meeting the postcondition after performing the first action indicates success of the first action; and second information, for an application programming interface (API), regarding a second action, the second action including an API call to the API, the second information further comprising inputs and outputs related to the API call, semantic descriptions for the API call, a precondition on when the API call can be executed, and a postcondition of successful completion of the API call; and deploying an agent for performing the task, the agent receiving the task from a user and obtaining, from a generative artificial intelligence (GAI) model, a plan for completing the task, the plan being based on the action index and comprising an operation for performing the first action on the GUI or the second action on the API.

Alternatively, or in addition to the other examples described herein, examples include any combination of the following:
Wherein the agent executes the plan, the execution of the plan comprising: determining that the first action or the second action is a next action according to the plan; when the first action is the next action according to the plan: receiving a GUI definition associated with the GUI; determining that the GUI definition meets the precondition for the first action; based on the GUI definition meeting the precondition for the first action, performing the action on the GUI; receiving a second GUI definition corresponding to a GUI screen displayed in response to the performing of the first action; determining that the second GUI definition meets the postcondition for the first action; and based on the second GUI definition meeting the postcondition for the first action, proceeding to a further action according to the plan; and when the second action is the next action according to the plan: receiving an API definition; determining that the API definition meets the precondition for the second action; based on the API definition meeting the precondition for the second action, performing the second action; receiving an API output responsive to the second action; determining that the API output responsive to the second action meets the postcondition for the second action; and based on the API output meeting the postcondition for the second action, proceeding to a further action according to the plan.
Wherein the GUI is a website and the GUI definition is hypertext markup language (HTML) code defining a user interface for the website.
Wherein the precondition is a presence, in the GUI definition, of a string, wherein the presence of the string indicates that the first action is likely to succeed.
Wherein the agent executes the plan, the execution of the plan comprising: determining that the first action is a next action according to the plan; receiving a GUI definition associated with the GUI; determining that the GUI definition does not meet the precondition for the first action; based on the GUI definition not meeting the precondition for the first action: retrieving a GUI image associated with the GUI, the GUI image being a representation of a GUI display corresponding to the GUI definition; providing the GUI definition and the GUI display to the GAI model; obtaining from the GAI model a replacement first action; performing the replacement first action; and upon successful outcome of the replacement first action, updating the first action index with information regarding the replacement first action.
Wherein, upon determining that the replacement first action resulted in an unsuccessful outcome: requesting and obtaining, via a user interface, user input; and obtaining, from the GAI model, a second replacement first action based on the user input and updating the action index with information regarding the second replacement first action.

An example computer-readable storage medium stores instructions executable by a processing apparatus to perform operations comprising: receiving a task from a client; providing the task to a generative artificial intelligence (GAI) model to obtain therefrom a plan for completing the task, the plan being based on an action index comprising information for an interface, the information indicating an action that can be performed on the interface, a first state of the interface within which the action is executable, and a second state of the interface in which the interface is placed after successful execution of the action; determining that the action is a next action in the plan; determining whether the interface is in the first state; and based on the interface being in the first state and the action being a next action in the plan, performing the action on the interface.
Wherein: the interface is generated by a web browser upon receipt of a hypertext markup language (HTML) source code form a web server; and the determination that the interface is in a first state comprises checking the HTML source code for a presence of a signature that indicates that the interface is in the first state and that the action is likely to result in the interface transitioning to the second state.
Wherein the plan comprises a state declaration and a verb declaration in a domain-specific language, the state declaration defining a precondition for the action and the verb declaration defining the action, the precondition indicating that the interface is in the first state.
Wherein the state declaration identifies an atom and a corresponding atom declaration defines the precondition, the atom corresponding to a collection of actionable elements of the interface, the collection including a target of the action, the target being one of a graphical user interface (GUI) element or an API command.
Wherein: the interface is a graphical user interface (GUI); the first state comprises the GUI displaying a first screen of information; the determination whether the GUI is in the first state comprises determining whether a signature of an actionable GUI element is present or absent in a GUI definition for the GUI, the GUI definition being a declarative description of the GUI; the operations further comprising: based on the signature being absent from the GUI definition: retrieving a GUI image associated with the GUI, the GUI image being an image representation of the first screen of information; providing the GUI definition and the GUI image to the GAI model; obtaining from the GAI model a replacement action; performing the replacement action; and upon a successful outcome of the replacement action, updating the action index with information regarding the replacement action.
Wherein, upon determining that the replacement action resulted in an unsuccessful outcome: requesting, via a user interface, user input; and obtaining, from the GAI model, a second replacement action based on the user input and updating the action index with information regarding the second replacement action.
Wherein: the interface is a graphical user interface (GUI); the action is for an actionable GUI element of the interface; the action index comprises information regarding the actionable GUI element; and the action index is organized as a directed graph wherein each node in the directed graph is a GUI screen and each edge is a respective action that transitions the interface from a first GUI screen to a second GUI screen, the edges having properties comprising a precondition and a postcondition, the precondition being a presence in the interface, of a signature indicating that the interface is in the first state and the postcondition being a presence in the interface of a signature indicating that the interface is in the second state.
Wherein the instructions are executable by a processing apparatus to perform further operations comprising providing personalization information to the GAI model, wherein the plan is based on the personalization information.

### Example Operating Environment

FIG. 11 is a block diagram of an example computing device 1100 (e.g., a computer storage device) for implementing aspects disclosed herein, and is designated generally as computing device 1100. In some examples, one or more computing devices 1100 are provided for an on-premises computing solution. In some examples, one or more computing devices 1100 are provided as a cloud computing solution. In some examples, a combination of on-premises and cloud computing solutions are used. Computing device 1100 is but one example of a suitable computing environment and is not intended to suggest any limitation as to the scope of use or functionality of the examples disclosed herein, whether used singly or as part of a larger set.

Neither should computing device 1100 be interpreted as having any dependency or requirement relating to any one or combination of components/modules illustrated. The examples disclosed herein can be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples can be practiced in a variety of system configurations, including personal computers, laptops, smart phones, mobile tablets, hand-held devices, consumer electronics, specialty computing devices, etc. The disclosed examples can also be practiced in distributed computing environments when tasks are performed by remote-processing devices that are linked through a communications network.

Computing device 1100 includes a bus 1110 that directly or indirectly couples the following devices: computer storage memory 1112, one or more processors 1114, one or more presentation components 1116, input/output (I/O) ports 1118, I/O components 1120, a power supply 1122, and a network component 1124. While computing device 1100 is depicted as a seemingly single device, multiple computing devices 1100 can work together and share the depicted device resources. For example, memory 1112 is distributed across multiple devices, and processor(s) 1114 is housed with different devices.

Bus 1110 represents one or more busses (such as an address bus, data bus, or a combination thereof). Although the various blocks of FIG. 11 are shown with lines for the sake of clarity, delineating various components can be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 11 and the references herein to a “computing device.” Memory 1112 can take the form of the computer storage media referenced below and operatively provide storage of computer-readable instructions, data structures, program modules and other data for the computing device 1100. In some examples, memory 1112 stores one or more of an operating system, a universal application platform, or other program modules and program data. Memory 1112 is thus able to store and access data 1112a and instructions 1112b that are executable by processor 1114 and configured to carry out the various operations disclosed herein.

In some examples, memory 1112 includes computer storage media. Memory 1112 can include any quantity of memory associated with or accessible by the computing device 1100. Memory 1112 can be internal to the computing device 1100 (as shown in FIG. 11), external to the computing device 1100 (not shown), or both (not shown). Additionally, or alternatively, the memory 1112 can be distributed across multiple computing devices 1100, for example, in a virtualized environment in which instruction processing is carried out on multiple computing devices 1100. For the purposes of this disclosure, “computer storage media,” “computer-storage memory,” “memory,” and “memory devices” are synonymous terms for the computer-storage memory 11012, and none of these terms include carrier waves or propagating signaling.

Processor(s) 1114 includes any quantity of processing units that read data from various entities, such as memory 1112 or I/O components 1120. Specifically, processor(s) 1114 are programmed to execute computer-executable instructions for implementing aspects of the disclosure. The instructions can be performed by the processor, by multiple processors within the computing device 1100, or by a processor external to the client computing device 1100. In some examples, the processor(s) 1114 are programmed to execute instructions such as those illustrated in the flow charts discussed below and depicted in the accompanying drawings. Moreover, in some examples, the processor(s) 1114 represent an implementation of analog techniques to perform the operations described herein. For example, the operations are performed by an analog client computing device 1100 and/or a digital client computing device 1100. Presentation component(s) 1116 present data indications to a user or other device. Exemplary presentation components include a display device, speaker, printing component, vibrating component, etc. It should be understood that computer data can be presented in a number of ways, such as visually in a graphical user interface (GUI), audibly through speakers, wirelessly between computing devices 1100, across a wired connection, or in other ways. I/O ports 1118 allow computing device 1100 to be logically coupled to other devices including I/O components 1120, some of which can be built in. Example I/O components 1120 include, for example but without limitation, a microphone, joystick, game pad, satellite dish, scanner, printer, wireless device, etc.

Computing device 1100 can operate in a networked environment via the network component 1124 using logical connections to one or more remote computers. In some examples, the network component 1124 includes a network interface card and/or computer-executable instructions (e.g., a driver) for operating the network interface card. Communication between the computing device 1100 and other devices can use any protocol or mechanism over any wired or wireless connection. In some examples, network component 1124 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 1124 communicates over wireless communication link 1126 and/or a wired communication link 1126a to a remote resource 1128 (e.g., a cloud resource) across network 1130. Various different examples of communication links 1126 and 1126a include a wireless connection, a wired connection, and/or a dedicated link, and in some examples, at least a portion is routed through the internet.

Although described in connection with an example computing device 1100, examples of the disclosure are capable of implementation with numerous other general-purpose or special-purpose computing system environments, configurations, or devices. Examples of well-known computing systems, environments, and/or configurations that suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices might accept input from the user in any way, including from input devices such as a keyboard or pointing device, via gesture input, proximity input (such as by hovering), and/or via voice input.

For simplicity and illustrative purposes, principles presented herein are described in reference to embodiments and examples thereof. Numerous specific details are set forth in order to provide an understanding of the embodiments and examples. It should be understood, however, that the embodiments and examples may be practiced without limitation to these specific details. In some instances, well-known methods and/or structures have not been described in detail so as not to unnecessarily obscure the description of the embodiments and examples. Furthermore, the embodiments and examples may be used together in various combinations.

References herein to “one embodiment,” “an embodiment,” “an example implementation,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

The terms “a” and “an” are intended to denote at least one of a particular element. As used herein, the term “includes” means includes but not limited to, the term “including” means “including but not limited to.”

Examples are described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform particular tasks or implement particular abstract data types. Aspects of the disclosure can be implemented with any number and organization of such components or modules. For example, aspects of the disclosure are not limited to the specific computer-executable instructions or the specific components or modules illustrated in the figures and described herein. Other examples of the disclosure include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium for storing information for access by a computing device. In contrast, communication media typically embody computer readable instructions, data structures, program modules, or the like in a modulated data signal such as a carrier wave or other transport mechanism and include any information delivery media.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

In examples involving a general-purpose computer, aspects of the disclosure transform the general-purpose computer into a special-purpose computing device when configured to execute the instructions described herein.

It will be understood that the benefits and advantages described above can relate to one embodiment or to several embodiments. The embodiments are not limited to those that solve any or all of the stated problems or those that have any or all of the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

In some examples, the operations illustrated in the figures are implemented as software instructions encoded on a computer storage medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing a particular operation before, contemporaneously with, or after another operation is within the scope of aspects of the disclosure.

As used herein, the term “set” is non-empty, and can also be referred to as a “group.”

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there might be additional elements other than the listed elements. The term “exemplary” is intended to mean “an example of.” The phrase “one or more of the following: A, B, and C” means “at least one of A and/or at least one of B and/or at least one of C.”

Below are specific example implementations offered here without limitation:

While the aspects of the disclosure have been described in terms of various examples with their associated operations, a person skilled in the art would appreciate that a combination of operations from any number of different examples is also within scope of the aspects of the disclosure.

What is claimed is:

1. A computer system comprising:
a processor; and
a memory storing instructions for execution by the processor, the instructions being operative upon execution by the processor to:
for a graphical user interface (GUI), obtain a GUI definition and a GUI image, the GUI definition being serialized code describing the GUI, and the GUI image being a representation of a GUI display corresponding to the GUI definition;
identify an actionable GUI element represented in the GUI definition and in the GUI image, the actionable GUI element being configured for receiving an interaction by a user;
identify a first action corresponding to the interaction;
extract a precondition and a postcondition corresponding to the first action, the precondition being a presence, prior to the execution of the first action, of a signature indicating that the actionable GUI element is present, the postcondition being a presence, after the execution of the first action and within a second GUI definition retrieved after execution of the first action, of a signature indicating an outcome from the first action;
for an application programming interface (API), obtain an API definition comprising inputs and outputs for the API, semantic descriptions, and information for invoking the API, and identify a second action corresponding to an API call to the API; and
update an action index with information that identifies the actionable GUI element, the first action, the precondition, the postcondition, and the second action, wherein the action index is made accessible by a generative artificial intelligence (GAI) model for generating a plan based on the action index to execute an automated task.

2. The computer system of claim 1, wherein the generating of the plan comprises receiving, by the GAI model, a task and instructions to create the plan based on the action index to complete the task, the plan comprising the first action or the second action.

3. The computer system of claim 1, wherein the instructions are further operative upon execution to validate the first action and the second action, the validation comprising:
obtaining a second GUI image;
providing the second GUI definition and the second GUI image to the GAI model;
requesting from the model, a confirmation, based on second GUI definition and the second GUI image, that the outcome was achieved;
obtaining output from the API in response to the second action;
providing the output from the API to the GAI model; and
requesting from the model, a second confirmation, based on the output from the API that the outcome was achieved.

4. The computer system of claim 1, wherein the actionable GUI element is part of an atom, the atom having a corresponding signature, the signature indicating that the atom is present.

5. The computer system of claim 4, wherein the GUI is one of a plurality of web pages published by a website, the atom is one of a plurality of atoms of the GUI, and the first action is one of a plurality of actions for the atom, instructions further being operative upon execution to iterate through the plurality of actions, the plurality of atoms, and the plurality of web pages.

6. The computer system of claim 1, wherein the action index is organized as a directed graph wherein each node in the directed graph is a GUI screen or API state and each edge is one of (i) a corresponding action that changes the GUI from one GUI screen to another, or (2) a corresponding API calls that changes the API from one state to another, the edges having properties comprising a corresponding precondition and a corresponding postcondition.

7. A computerized method for performing a task, the method comprising:
generating an action index, the action index comprising:
first information, for a graphical user interface (GUI), regarding an actionable GUI element of a GUI screen, the first information comprising a first action for the actionable GUI element, a precondition for the first action, and a postcondition for the first action, wherein the GUI meeting the precondition indicates a likelihood of success of the first action, and the GUI meeting the postcondition after performing the first action indicates success of the first action; and
second information, for an application programming interface (API), regarding a second action, the second action including an API call to the API, the second information further comprising inputs and outputs related to the API call, semantic descriptions for the API call, a precondition on when the API call can be executed, and a postcondition of successful completion of the API call; and
deploying an agent for performing the task, the agent receiving the task from a user and obtaining, from a generative artificial intelligence (GAI) model, a plan for completing the task, the plan being based on the action index and comprising an operation for performing the first action on the GUI or the second action on the API.

8. The computerized method of claim 7, wherein the agent executes the plan, the execution of the plan comprising:
determining that the first action or the second action is a next action according to the plan;
when the first action is the next action according to the plan:
receiving a GUI definition associated with the GUI;
determining that the GUI definition meets the precondition for the first action;
based on the GUI definition meeting the precondition for the first action, performing the action on the GUI;
receiving a second GUI definition corresponding to a GUI screen displayed in response to the performing of the first action;
determining that the second GUI definition meets the postcondition for the first action; and
based on the second GUI definition meeting the postcondition for the first action, proceeding to a further action according to the plan; and
when the second action is the next action according to the plan:
receiving an API definition;
determining that the API definition meets the precondition for the second action;
based on the API definition meeting the precondition for the second action, performing the second action;
receiving an API output responsive to the second action;
determining that the API output responsive to the second action meets the postcondition for the second action; and
based on the API output meeting the postcondition for the second action, proceeding to a further action according to the plan.

9. The computerized method of claim 8, wherein the GUI is a website and the GUI definition is hypertext markup language (HTML) code defining a user interface for the website.

10. The computerized method of claim 8, wherein the precondition is a presence, in the GUI definition, of a string, wherein the presence of the string indicates that the first action is likely to succeed.

11. The computerized method of claim 7, wherein the agent executes the plan, the execution of the plan comprising:
determining that the first action is a next action according to the plan;
receiving a GUI definition associated with the GUI;
determining that the GUI definition does not meet the precondition for the first action;
based on the GUI definition not meeting the precondition for the first action:
retrieving a GUI image associated with the GUI, the GUI image being a representation of a GUI display corresponding to the GUI definition;
providing the GUI definition and the GUI display to the GAI model;
obtaining from the GAI model a replacement first action;
performing the replacement first action; and
upon successful outcome of the replacement first action, updating the first action index with information regarding the replacement first action.

12. The computerized method of claim 11, wherein, upon determining that the replacement first action resulted in an unsuccessful outcome:
requesting and obtaining, via a user interface, user input; and
obtaining, from the GAI model, a second replacement first action based on the user input and updating the action index with information regarding the second replacement first action.

13. A computer-readable storage medium storing instructions executable by a processing apparatus to perform operations comprising:
receiving a task from a client;
providing the task to a generative artificial intelligence (GAI) model to obtain therefrom a plan for completing the task, the plan being based on an action index comprising information for an interface, the information indicating an action that can be performed on the interface, a first state of the interface within which the action is executable, and a second state of the interface in which the interface is placed after successful execution of the action;
determining that the action is a next action in the plan;
determining whether the interface is in the first state; and
based on the interface being in the first state and the action being a next action in the plan, performing the action on the interface.

14. The computer-readable storage medium of claim 13, wherein:
the interface is generated by a web browser upon receipt of a hypertext markup language (HTML) source code form a web server; and
the determination that the interface is in a first state comprises checking the HTML source code for a presence of a signature that indicates that the interface is in the first state and that the action is likely to result in the interface transitioning to the second state.

15. The computer-readable storage medium of claim 13, wherein the plan comprises a state declaration and a verb declaration in a domain-specific language, the state declaration defining a precondition for the action and the verb declaration defining the action, the precondition indicating that the interface is in the first state.

16. The computer-readable storage medium of claim 15, wherein the state declaration identifies an atom and a corresponding atom declaration defines the precondition, the atom corresponding to a collection of actionable elements of the interface, the collection including a target of the action, the target being one of a graphical user interface (GUI) element or an API command.

17. The computer-readable storage medium of claim 13, wherein:
the interface is a graphical user interface (GUI);
the first state comprises the GUI displaying a first screen of information;
the determination whether the GUI is in the first state comprises determining whether a signature of an actionable GUI element is present or absent in a GUI definition for the GUI, the GUI definition being a declarative description of the GUI;
the operations further comprising:
based on the signature being absent from the GUI definition:
retrieving a GUI image associated with the GUI, the GUI image being an image representation of the first screen of information;
providing the GUI definition and the GUI image to the GAI model;
obtaining from the GAI model a replacement action;
performing the replacement action; and
upon a successful outcome of the replacement action, updating the action index with information regarding the replacement action.

18. The computer-readable storage medium of claim 17, wherein, upon determining that the replacement action resulted in an unsuccessful outcome:
requesting, via a user interface, user input; and
obtaining, from the GAI model, a second replacement action based on the user input and updating the action index with information regarding the second replacement action.

19. The computer-readable storage medium of claim 13, wherein:
the interface is a graphical user interface (GUI);
the action is for an actionable GUI element of the interface;
the action index comprises information regarding the actionable GUI element; and
the action index is organized as a directed graph wherein each node in the directed graph is a GUI screen and each edge is a respective action that transitions the interface from a first GUI screen to a second GUI screen, the edges having properties comprising a precondition and a postcondition, the precondition being a presence in the interface, of a signature indicating that the interface is in the first state and the postcondition being a presence in the interface of a signature indicating that the interface is in the second state.

20. The computer-readable storage medium of claim 19, wherein the instructions are executable by a processing apparatus to perform further operations comprising providing personalization information to the GAI model, wherein the plan is based on the personalization information.
